(19) United States
(12) Patent Application Publication
(10) Pub. No.: US 2011/0128503 A1
(43) Pub. Date: Jun. 2, 2011

(54) STEREOSCOPIC IMAGE PROJECTOR

(75) Inventors: Yasumasa SAWAI, Yamatotakada-shi (JP); Jun ISHIHARA, Kobe-shi (JP)

(73) Assignee: Konica Minolta Opto, Inc., Tokyo (JP)

(21) Appl. No.: 12/948,444

(22) Filed: Nov. 17, 2010

(30) Foreign Application Priority Data
Nov. 27, 2009 (JP) 2009-269780

(51) Int. Cl. G02B 27/26; G03B 21/14; G02B 27/22

(52) U.S. Cl. 353/8; 353/7

(57) ABSTRACT

A stereoscopic image projector is provided with a display device, a characteristic-differentiation member, an optical-path separation member, an optical-path combining member, and a single projection lens. The display device displays a left-eye image which is a left parallax image and a right-eye image which is a right parallax image on different regions of an image display surface. The characteristic-differentiation member gives projection light beams each carrying a different one of images displayed on the display device optical characteristics that are different from each other. By using the difference in optical characteristic, the optical-path separation member separates optical paths of the left-eye and right-eye images from each other, and the optical-path combining member coaxially combines the separated optical paths together. The projection lens, by using the combined projection light beams, superimposingly projects, onto a screen, the right-eye and left-eye images having the optical characteristics that are different from each other.

This application is based on Japanese Patent Application No. 2009-269780 filed on Nov. 27, 2009, the contents of which are hereby incorporated by reference.

### BACKGROUND OF THE INVENTION

1. Field of the Invention

The present invention relates to a stereoscopic image projector, and specifically relates to a stereoscopic image projector that projects a left-eye image (image for a left eye) and a right-eye image (image for a right eye), which are a left parallax image and a right parallax image, respectively, on a screen in a superimposed manner.

2. Description of Related Art

Patent Document 1 proposes a stereoscopic image projector configured such that left and right parallax images are displayed on different image-display areas of one display device, and on the way through a projection lens, the optical path is separated into two, namely, one for the left eye and the other for the right eye, to project an image practically by using two projection lenses. Patent Document 2 discloses a stereoscopic image projector configured such that optical paths for left and right parallax images are separated from each other by a mirror disposed on the screen side of a projection lens, to project an image practically by using two projection lenses. With the configuration where image projection is performed practically by using two projection lenses like in these projectors, some adjustment is necessary in superimposing left and right parallax images on a screen. This requires readjustment by the user for every change in setting condition such as the projection distance. In contrast, a configuration in which projection is performed by using a single projection lens does not require readjustment by the user for different setting conditions, and Patent Document 3 proposes a stereoscopic image projector having such a configuration.
Patent Document 1: JP-A-2007-271828
Patent Document 2: JP-A-2005-62607
Patent Document 3: JP-A-2001-337295

The stereoscopic image projector proposed in Patent Document 3 is configured such that left and right parallax images are displayed on different image display regions of one display device, light carrying one of the images is reflected by a mirror to be separated from light carrying the other image, different polarization characteristics are given to the light carrying the one image and the light carrying the other image, and thereafter, the light carrying the one image and the light carrying the other image are combined together by a polarization beam splitter, to be projected through a single projection lens. Thus, no readjustment by a user is necessary for different setting conditions. The optical-path separation by the mirror, however, is carried out at a position that is quite far away from the display device, and thus the left parallax-image light and the right parallax-image light overlap each other at a boundary portion. In other words, no consideration is given to the F-number and the separation is not clear enough at the boundary portion when the optical paths are separated from each other, which results in a mixture of the optical paths of the light carrying the right-eye image and the light carrying the left-eye image. Thus, such inefficient optical path separation results in deterioration of projection image quality. Furthermore, since the optical path of the light carrying the left parallax image and the optical path of the light carrying the right parallax image are combined together with a difference in optical-path length, if one of the images is brought into focus, the other image is out of focus. That is, displacement occurs between the focusing states of the left and right parallax images due to the difference in optical-path length.

The stereoscopic image projector proposed in Patent Document 2 also suffer from the same problem as the stereoscopic image projector proposed in Patent Document 3. That is, at the position where the mirror is disposed, the left and right parallax images overlap each other at the boundary portion, and the light carrying the right-eye image enters the optical path of the light carrying the left-eye image. In addition, since the light carrying the left parallax image and the light carrying the right parallax image are different from each other in optical-path length to the screen, one of the images is out of focus. Furthermore, the light carrying the left parallax image and the light carrying the right parallax image are projected onto the screen at different projection angles, and thus a difference is also observable between trapezoidal distortions of the two images.

### SUMMARY OF THE INVENTION

The present invention has been made in view of the foregoing, and an object of the present invention is to provide a compact stereoscopic image projector capable of performing high-quality image projection by securely separating the optical path of light carrying a right-eye image from the optical path of light carrying a left-eye image, to reduce degradation of image quality caused by mixture of the light carrying the right-eye image and the light carrying the left-eye image occurring at a boundary portion between the optical paths.

According to one aspect of the present invention, a stereoscopic image projector is provided with: a display device that displays a left-eye image which is a left parallax image and a right-eye image which is a right parallax image on different regions of an image display surface; a characteristic-differentiation member that gives optical characteristics that are different from each other to different projection light beams each carrying a different one of images displayed on the display device; an optical-path separation member that separates optical paths of the different projection light beams having obtained the optical characteristics that are different from each other at the characteristic-differentiation member into an optical path of the right-eye image and an optical path of the left-eye image by using a difference between the optical characteristics; an optical-path combining member that coaxially combines, by using the difference between the optical characteristics, the optical path of the right-eye image and the optical path of the left-eye image having been separated from each other by the optical-path separation member; and a single projection lens that superimposingly projects the right-eye image and the left-eye image having the optical characteristics that are different from each other onto a screen by using a projection light beam resulting from coaxial combining of optical paths performed by the optical-path combining member.

According to another aspect of the present invention, a stereoscopic image projector is provided with: a display device that displays a left-eye image which is a left parallax image and a right-eye image which is a right parallax image on different regions of an image display surface; a relay optical system that forms an intermediate image of the right-eye image and an intermediate image of the left-eye image; a characteristic-differentiation member that gives optical characteristic that are different from each other to different projection light beams each carrying a different one of intermediate images formed by the relay optical system; an optical-path separation member that separates optical paths of the different projection light beams having obtained the optical characteristics that are different from each other at the characteristic-differentiation member into an optical path of the right-eye image and an optical path of the left-eye image by using a difference between the optical characteristics; an optical-path combining member that coaxially combines, by using the difference between the optical characteristics, the optical path of the right-eye image and the optical path of the left-eye image having been separated from each other by the optical-path separation member; and a single projection lens that superimposingly projects the right-eye image and the left-eye image having the optical characteristics that are different from each other onto a screen by using a projection light beam resulting from coaxial combining of optical paths performed by the optical-path combining member.

### BRIEF DESCRIPTION OF THE DRAWINGS

FIG. 1 is a diagram schematically showing the configuration of a first embodiment of a stereoscopic image projector;

FIG. 2 is a plan view showing an image display surface of a display device;

FIG. 3 is a diagram schematically showing the configuration of a second embodiment of the stereoscopic image projector;

FIG. 4 is a diagram schematically showing a first modified example of a relay optical system for projection;

FIG. 5 is a diagram schematically showing a second modified example of the relay optical system for projection; and

FIG. 6 is an optical path diagram showing the difference in optical-path length between left and right parallax images.

### DETAILED DESCRIPTION OF PREFERRED EMBODIMENTS

Hereinafter, a description will be given of embodiments, etc. of a stereoscopic image projector of the present invention, with reference to the drawings. In different embodiments, etc., the equivalent or corresponding parts are identified by the same reference signs, and overlapping description of the same parts will be adequately omitted.

### First Embodiment

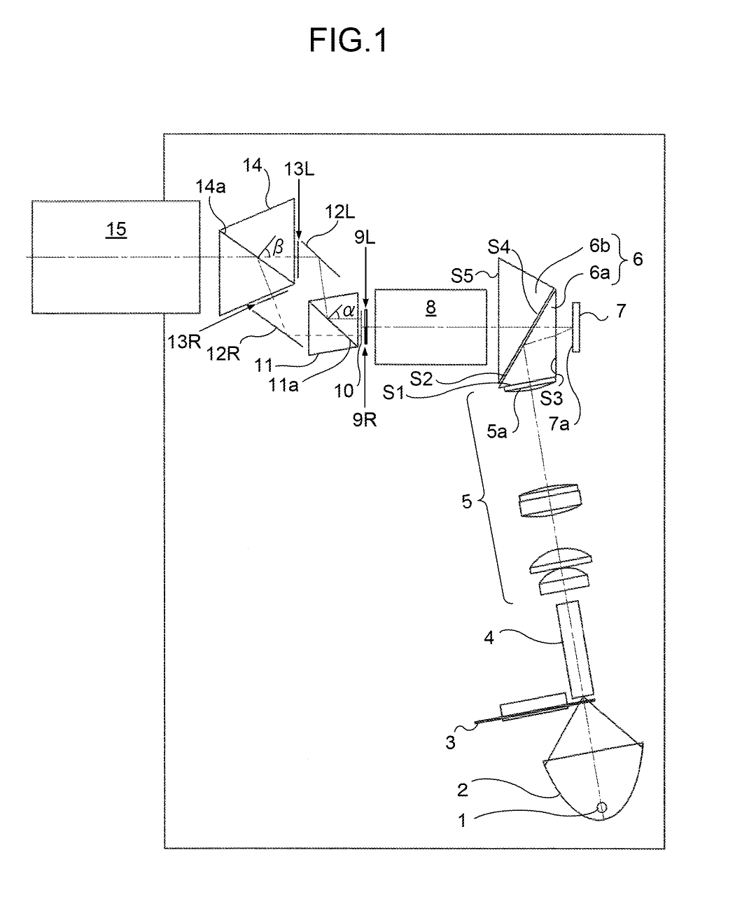

### FIGS. 1, 2 and 6

FIG. 1 is a diagram showing the stereoscopic image projector of a first embodiment as seen from above. In FIG. 1, reference numeral 1 denotes a light source, reference numeral 2 denotes a lamp reflector, reference numeral 3 denotes a color wheel, reference numeral 4 denotes a rod integrator, reference numeral 5 denotes a relay optical system for illumination, reference numeral 6 denotes a critical angle prism, reference numeral 7 denotes a display device, reference numeral 8 denotes a relay optical system for projection, reference numerals 9R, 9L denote first and second polarization plate, respectively, reference numeral 10 denotes intermediate images, reference numeral 11 denotes a polarization beam splitter for optical-path separation, reference numerals 12R, 12L denote deflection mirrors, reference numerals 13R, 13L denote ½ wave plates, reference numeral 14 denotes a polarization beam splitter for combining optical paths, and reference numeral 15 denotes a projection lens. Incidentally, the rod integrator 4 and the polarization direction at the critical angle prism 6 are skew to each other at an angle of 45°, but they are shown in a developed manner in FIG. 1 for ease of understanding.

The light source 1 is formed of a discharge lamp (for example, an ultra high pressure mercury lamp) that emits white light. A reflection surface of the lamp reflector 2 is an ellipsoidal surface, at the focal position of which the light source 1 is disposed. That is, the lamp reflector 2 is an ellipsoidal-surface mirror (a condenser optical system) that condenses light emitted from the light source 1 to form a secondary light source, and light beams from the light source 1 is reflected by the lamp reflector 2 to be emitted as convergent light. Incidentally, the image-forming position of the convergent light is an entrance end face of the rod integrator 4 (or in the vicinity thereof).

The convergent light leaving the lamp reflector 2 enters the color wheel 3, which changes the color of light that passes therethrough in a time-division manner for achieving color display. The color wheel 3 is formed of a color filter for illuminating the display device 7 by using a color sequential method. For example, it is formed of color filters transmitting light of R (red), G (green), and B (blue), respectively. When the color wheel 3 is rotated, a filter portion located at the illumination light transmitting position is rotationally moved, and thereby the color of light for illumination is changed in a temporally sequential manner. Thus, by displaying image information corresponding to each color on the display device 7, it is possible to colorize a projection image.

After passing through the color wheel 3, the convergent light enters the rod integrator 4. The rod integrator 4 is light intensity unifomization means formed as a hollow rod by adhering four flat-surface mirrors with each other, and has its entrance end face located in the vicinity of the secondary light source. Illumination light that enters the rod integrator 4 through the entrance end face is mixed by being repeatedly reflected over and over again by side surfaces (that is, inner wall surfaces) of the rod integrator 4, to be projected from an exit end face as illumination light having uniform spatial energy distribution. The shape of the entrance end face and the shape of the exit end face (that is, the cross-section shape) of the rod integrator 4 are a quadrangular shape that is similar (or substantially similar) to the shape of an image display surface 7a of the display device 7, and the exit end face of the rod integrator 4 and the image display surface 7a of the display device 7 are conjugated (substantially conjugated) by the relay optical system 5 for illumination. Thus, with the distribution of brightness at the exit end face made uniform by the mixing effect described above, the image display surface 7a of the display device 7 is uniformly illuminated efficiently. That is, a plurality of secondary light source images are formed at a pupil position of the relay optical system 5 according to the number of times of reflections within the rod integrator 4, and the images are superimposed on each other by the relay optical system 5, and thereby, uniform illumination is realized.

The rod integrator 4 is not limited to a hollow rod, and it may be a glass rod formed of a quadrangular-prism shaped glass body. Furthermore, the rod integrator 4 is not limited to have four side surfaces, and it may have any number of side surfaces as long as its shape fits the shape of the image display surface 7a of the display device 7. Thus, examples of the rod integrator 4 to be used include a hollow cylindrical body formed by combining a plurality of deflection mirrors, a polygonal prism-shaped glass body, and the like.

Illumination light leaving the rod integrator 4 passes through the relay optical system 5 for illumination, and then enters the critical angle prism 6. The critical angle prism 6 is formed of two prisms, namely, a first prism 6a and a second prism 6b. The first prism 6a has a first incidence surface S1, a critical surface S2, and a first emission surface S3, and the second prism 6b has a second incidence surface S4 and a second emission surface S5. The critical surface S2 of the first prism 6a and the second incidence surface S4 of the second prism 6b are arranged to face each other with a layer of air therebetween.

The first incidence surface S1 of the first prism 6a has adhered thereon an entrance lens 5a, which forms part of the relay optical system 5. The entrance lens 5a is provided to make the illumination light telecentric. Instead of adhering the entrance lens 5a to the first incidence surface S1, the first incidence surface S1 of the first prism 6a may be formed as a curved surface so that the first prism 6a has the function of the entrance lens 5a. As already described, the relay optical system 5 relays the illumination light to form an image of the exit end face of the rod integrator 4 on the image display surface 7a of the display device 7. That is, the image of the exit end face of the rod integrator 4 is formed on the image display surface 7a of the display device 7.

The illumination light passes through the entrance lens 5a to enter the first prism 6a through the first incidence surface S1. The critical surface S2 of the first prism 6a is arranged so as to totally reflect the illumination light. Thus, the illumination light is reflected by the critical surface S2 to be emitted from the first emission surface S3 of the first prism 6a, to illuminate the image display surface 7a of the display device 7.

On the image display surface 7a of the display device 7, a two-dimensional image is formed by modulating the intensity of the illumination light. Here, the display device 7 is assumed to be a digital micromirror device. This, however, is not meant to limit the display device 7 to be used, and any other reflection-type display device (for example, a liquid crystal display device) suitable for the projection system may be used instead. A pixel of the digital micromirror device has an axis of rotation that forms an angle of 45° with a side of a rectangle image display region that the image display surface 7a forms, and the pixel is rotated, for example, by ±12° around the axis of rotation, to achieve an ON or OFF state.

In a case where a digital micromirror device is used as the display device 7, light incident thereon is spatially modulated by being reflected by the micromirrors which are individually either in the ON or OFF state (for example, states tilted by ±12°). Here, by allowing merely light that is reflected by a micromirror in the ON state to pass through the critical angle prism 6, the image displayed on the display device 7 is projected onto a screen (not shown) in a magnified manner. That is, in an image-display state, light beams (that is, projection light) reflected by the micromirror in the ON state reenters the first prism 6a through the first emission surface S3 of the first prism 6a, and reaches the critical surface S2 of the first prism 6a. The projection light is incident on the critical surface S2 at an angle that does not fulfill the condition for total reflection, and thus is transmitted through the critical surface S2 to enter, via the layer of air, the second prism 6b through the second incidence surface S4. The projection light emitted from the second emission surface S5 of the second prism 6b reaches the screen via a projection optical system formed of the relay optical system 8 and the projection lens 15, and forms a projection image of the image formed on the image display surface 7a.

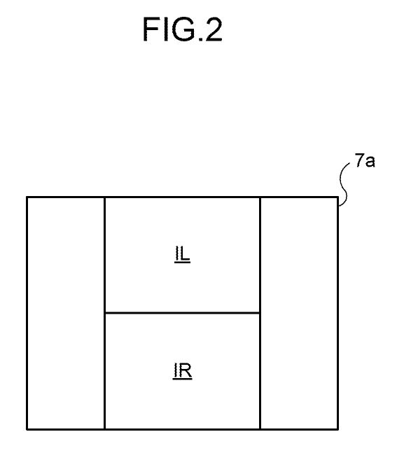

In the image display region on the image display surface 7a, for example, a left-eye image IL is displayed on the upper half, and a right-eye image IR is displayed on the bottom half as shown in FIG. 2. That is, the display device 7 displays the left-eye image IL and the right-eye image IR, which are left and right parallax images, respectively, on different regions of the image display surface 7a. Intermediate images 10 of the images IR and IL are formed by the relay optical system 8 for projection. At (or in the vicinity of) positions where the intermediate images 10 are formed, the first and second polarization plates 9R and 9L are arranged. Specifically, the first polarization plate 9R is arranged in the right-eye image IR region of the intermediate images 10, and the second polarization plate 9L is arranged in the left-eye image IL region of the intermediate images 10. The first and second polarization plates 9R and 9L are characteristic-differentiation members that give optical characteristics that are different from each other to a projection light beam carrying the image IR and a projection light beam carrying the image IL, both of the images IR and IL being displayed on the display device 7. In this embodiment, “optical characteristics that are different from each other” are polarization characteristics of linearly polarized light beams that are perpendicular to each other, and thus the projection light beam carrying the right-eye image IR coming from the first polarization plate 9R and the projection light beam carrying the left-eye image IL coming from the second polarization plate 9L have the characteristics of linearly polarized light beams that are perpendicular to each other.

After passing through the first and second polarization plates 9R and 9L, the projection light beams carrying the images IR and IL enter the polarization beam splitter 11 for optical-path separation. The polarization beam splitter 11 for optical-path separation used here is an optical-path separation prism that is structured to be able to perform satisfactory separation of polarization at an incidence angle of 49.5° by forming, for example, a polarization separation surface 11a as a multilayer film of SiO₂ having a refractive index of approximately 1.474 and a mixture of La₂O₃ and Al₂O₃ having a refractive index of approximately 1.845 on a prism medium having a refractive index of approximately 1.5168.

The polarization beam splitter 11 for optical-path separation is an optical-path separation member that separates the optical paths of the projection light beams, given optical characteristics that are different from each other by the first and second polarization plates 9R and 9L, from each other as an optical path of the right-eye image IR and an optical path of the left-eye image IL by using the difference in optical characteristic. Specifically, the projection light beam carrying the right-eye image IR, having been linearly polarized by the first polarization plate 9R, is incident on, and passes through, the polarization separation surface 11a of the polarization beam splitter 11 for optical-path separation as a P-polarized light beam. On the other hand, the projection light beam carrying the left-eye image IL, having been linearly polarized in a direction perpendicular to the polarization direction of the right-eye image IR by the second polarization plate 9L, is incident on the polarization separation surface 11a of the polarization beam splitter 11 for optical-path separation as S-polarization and reflected thereby.

The projection light beams carrying the images IR and IL coming out of the polarization beam splitter 11 are reflected by the deflection mirrors 12R and 12L to pass through the ½ wave plates 13R and 13L, respectively, and enter the polarization beam splitter 14 for combining optical paths. The polarization beam splitter 14 for combining optical paths used here is an optical-path combining prism that is structured to be able to perform satisfactory polarization separation at an incidence angle of 56° by forming, for example, a polarization combining surface 14a as a multilayer film of SiO₂ having a refractive index of approximately 1.474 and TiO₂ having a refractive index of approximately 2.41 on a prism medium having a refractive index of approximately 1.5168.

The polarization beam splitter 14 for combining optical paths is an optical-path combining member that coaxially combines, by using the difference in optical characteristic, the optical path of the right-eye image IR and the optical path of the left-eye image IL that have been separated from each other by the polarization beam splitter 11. Specifically, the projection light beam carrying the right-eye image IR and leaving the polarization beam splitter 11 is reflected by the deflection mirror 12R to be incident on the ½ wave plate 13R, and the polarization direction of the projection light beam is changed by 90°. Then, the projection light beam is incident, as an S-polarized light beam, on the polarization combining surface 14a of the polarization beam splitter 14 for combining optical paths, to be reflected thereby. On the other hand, the projection light beam carrying the left-eye image IL and leaving the polarization beam splitter 11 is reflected by the deflection mirror 12L to be incident on the ½ wave plate 13L, and the polarization direction of the projection light beam is changed by 90°. Then, the projection light beam is incident, as a P-polarized light beam, on the polarization combining surface 14a of the polarization beam splitter 14 for combining optical paths, to pass therethrough.

The projection light beams carrying the images IR and IL and leaving the polarization beam splitter 14 are projected via the projection lens 15 onto the screen superimposed on each other. That is, the projection lens 15, by using the projection light beams whose optical paths are coaxially combined by the polarization beam splitter 14, superimposingly projects the right-eye image IR and the left-eye image IL, having different optical characteristics, onto the screen. At this time, since the right-eye image IR and the left-eye image IL have different polarization characteristics, when the screen is looked at via polarization glasses where a polarization plate that transmits merely the polarization component of the right-eye image IR is attached to its right-eye portion while a polarization plate that transmits merely the polarization component of the left-eye image IL is attached to its left-eye portion, the image projected onto the screen can be appreciated as a stereoscopic image. In addition, at this time, to superimpose the left-eye and right-eye images with improved accuracy, the polarization beam splitters 11 and 14, the deflection mirrors 12R and 12L, and the like may be provided with an adjustment mechanism. Accurate superimposition of the left-eye and right-eye images relieves sense of incongruity and fatigue a user may feel while appreciating stereoscopic images, and furthermore, allows satisfactory appreciation, without polarization glasses, of non-stereoscopically displayed projection images with this optical system.

In the first embodiment, light beams from the light source 1 are condensed to the rod integrator 4 at a converging angle of approximately 60°, and thus an NA (numerical aperture) is 0.5 at the exit end face of the rod integrator 4. The relay optical system 5 for illumination magnifies the images formed on the exit end face of the rod integrator 4 by 2.5 times, and illuminates the image display surface 7a of the display device 7 with a light beam having an NA of 0.2. The relay optical system 8 for projection relays the images formed on the image display surface 7a at a magnification of 1:1, and forms the intermediate images 10 with a light beam having an NA of 0.2. As a result, the light beams carrying the intermediate images 10 have angle distribution of approximately 23°, and the farther the light beams are from the intermediate images 10, the more the light beams carrying the left-eye and right-eye images IL and IR are mixed together, and particularly at the boundary portion between the images IR and IL, the light beams are mixed together quickly. However, the first and second polarization plates 9R and 9L are arranged in the vicinity of the intermediate images 10, where the light beams are not so much mixed together, to give different polarization characteristics to the light beams carrying the right-eye and left-eye images, and thus, even after the first and second polarization plates 9R and 9L, where the light beams are more mixed together, satisfactory optical-path separation can be performed by the polarization beam splitter 11 for optical-path separation.

As described above, optical-path separation is carried out by using difference in optical characteristic, that is, difference in polarization characteristic, and this prohibits the intermediate images 10 having a specific NA, namely, the intermediate image of the right-eye image IR and the intermediate image of the left-eye image IL from mixing into each other during the optical-path separation. Thus, since the optical path of the light carrying the right-eye image and the optical path of the light carrying the left-eye image can be securely separated from each other, it is possible to prevent deterioration of image quality due to mixture of image light beams occurring at a boundary portion between optical paths, and thus to realize a high-quality image projection. Furthermore, since projection is performed by using the single projection lens 15, readjustment by the user is not necessary even when a setting condition such as the projection distance is changed. Moreover, since there is no difference in projection angle with respect to the screen between light beams carrying left and right parallax images, no difference occurs in trapezoidal distortion between the images.

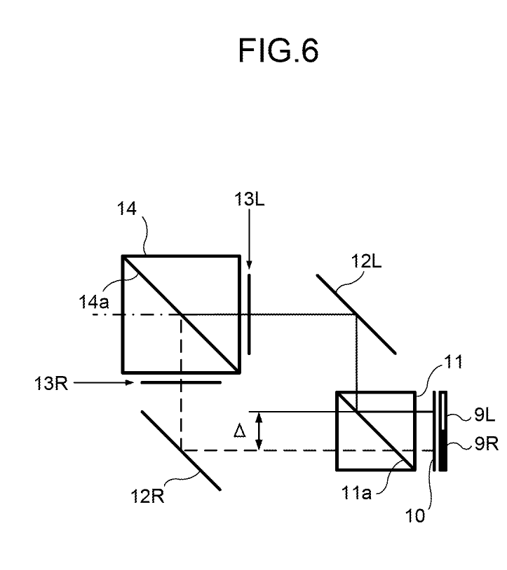

In the configuration of the first embodiment, the two images IR and IL (see FIG. 2) are combined with a compact configuration by folding each optical path twice. Furthermore, since the optical paths of the light beams carrying left and right parallax images are combined to achieve a state where there is no difference in optical-path length between the two images, there is no occurrence of a problem that, when one of the images is in focus, the other image is out of focus. That is, displacement due to difference in optical-path length does not occur between the focusing states of the left and right parallax images. Here, a configuration will be discussed where the polarization beam splitter 11 for optical-path separation and the polarization beam splitter 14 for combining optical paths carry out separation and combining, respectively, of polarization at the same incidence angle as shown in FIG. 6 (incidentally, in the configuration shown in FIG. 6, the incidence angles with respect to the polarization separation surface 11a and the polarization combining surface 14a are both 45°).

As shown in FIG. 6, when the light path of the right-eye image IR via the first polarization plate 9R and the light path of the left-eye image IL via the second polarization plate 9L are coaxially synthesized together, the optical path of the right-eye image IR is longer than that of the left-eye image IL by the length A corresponding to the distance between the intermediate images 10 of the images IR and IL. In contrast, In the configuration of the first embodiment (see FIG. 1), in both the optical paths of the right-eye image IR and the left-eye image IL, an incidence angle (separation angle) α with respect to the polarization separation surface 11a and an incidence angle (combining angle)β with respect to the polarization combining surface 14a are different from each other (although FIG. 1 shows the incidence angles α, β in the optical path of the left-eye image IL, the same applies to the right-eye image IR), the optical path of the right-eye image IR and the optical path of the left-eye image IL both have the same length from the display device 7 to the projection lens 15. By making the separation angle α and the combining angle β different from each other in this way, a compact arrangement of the separation and combining of optical paths can be achieved without causing any difference in optical-path length.

### Second Embodiment

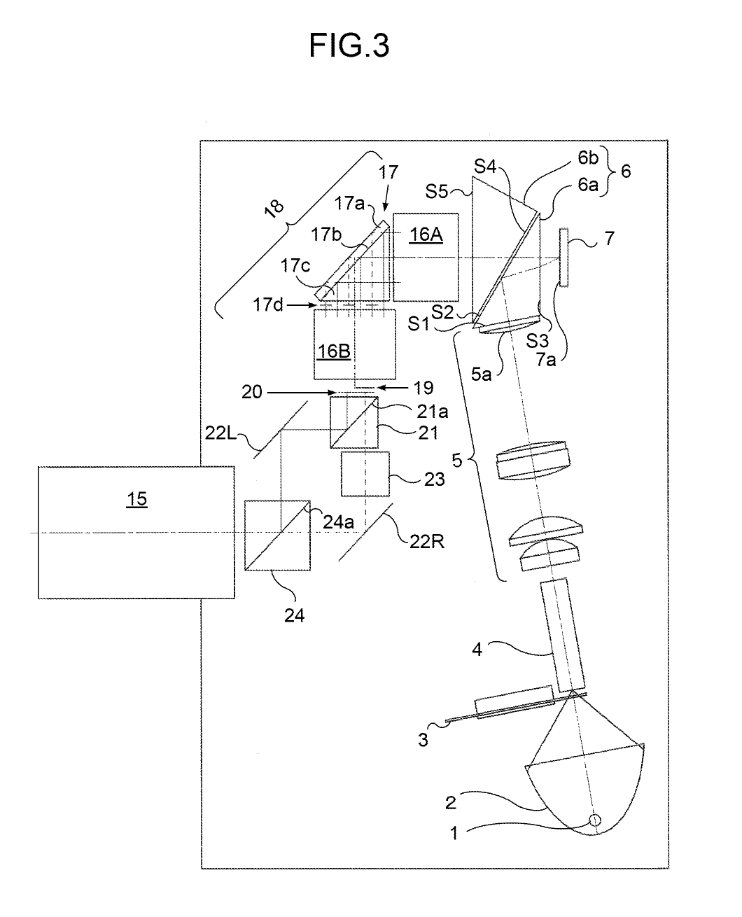

### FIG. 3

FIG. 3 shows a second embodiment of the stereoscopic image projector as seen from above. In FIG. 3, reference numeral 1 denotes a light source, reference numeral 2 denotes a lamp reflector, reference numeral 3 denotes a color wheel, reference numeral 4 denotes a rod integrator, reference numeral 5 denotes a relay optical system for illumination, reference numeral 6 denotes a critical angle prism, reference numeral 7 denotes a display device, reference numeral 18 denotes a relay optical system for projection, reference numeral 19 denotes a ½ wave plate, reference numeral 20 denotes intermediate images, reference numeral 21 denotes a polarization beam splitter for optical-path separation, reference numerals 22R, 22L denote deflection mirrors, reference numeral 23 denotes an optical-path length correction plate, reference numeral 24 denotes a polarization beam splitter for combining optical paths, and reference numeral 15 denotes a projection lens.

The first and second embodiments are similar to each other in terms of the structure from the light source 1 to the critical angle prism 6. That is, it is in terms of the relay optical system 18 for projection, the ½ wave plate 19 (characteristic-differentiation member), and optical-path separation/combining portions (formed of an optical-path separation member, an optical-path combining member, and an optical-path length collection member) that the second embodiment is different from the first embodiment. The relay optical system 18 for projection is formed of a front group 16B that is located closer to a screen than a pupil position is, a rear group 16A that is located closer to the display device 7 than the pupil position is, and a polarization conversion optical system 17 incorporated between the front and rear groups 16B and 16A. The polarization conversion optical system 17 is formed of a parallel flat plate 17a, a polarization beam splitter formed of a polarization separation surface 17b and a triangular prism 17c, and a plurality of ½ wave plates 17d placed at the pupil position.

The pupil position of the relay optical system 18 for projection is conjugated with the pupil position of the relay optical system 5 for illumination, and a plurality of secondary light source images are formed at the pupil position. A projection light beam from the rear group 16A enters the triangular prism 17c, and S-polarized light of the projection light beam is reflected by the polarization separation surface 17b, to form secondary light source images of S-polarization component at the pupil position. P-polarized light of the projection light beam passes through the polarization separation surface 17b, and is reflected by a reflection surface of the parallel flat plate 17a to pass through the polarization separation surface 17b again, to form secondary light source images of P-polarization component at the pupil position. The secondary light source images of P-polarization component are formed at positions that are displaced from the positions where the secondary light source images of S-polarization component are formed by a distance corresponding to the thickness of the parallel flat plate 17a, and at the positions, the ½ wave plates 17d are arranged. The ½ wave plates 17d convert the secondary light source images of P-polarization component to secondary light source images of S-polarization-component, to thereby unify the polarization of all the secondary light source images to S-polarization. As a result, the intermediate images 20 formed by the relay optical system 18 for projection is formed in a state of uniform linear polarization.

At (or in the vicinity of) the positions where the intermediate images 20 are formed, the ½ wave plate 19 is disposed corresponding to the image region of the right-eye image IR. The ½ wave plate 19 converts the polarization direction of incident light by 90 degrees to emit a linearly polarized light beam having a polarization direction different from that of the left-eye image IL. As a result, the polarization component of the left-eye image IL and the polarization component of the right-eye image IR are perpendicular to each other. That is, the ½ wave plate 19 is a characteristic-differentiation member that makes the projection light beams of the images IR and IL displayed on the display device 7 have optical characteristics that are different from each other. The “optical characteristics that are different from each other” are the polarization characteristics of linearly polarized light beams that are perpendicular to each other, and thus the projection light beam carrying the right-eye image IR that has passed through the ½ wave plate 19 and the projection light beam carrying the left-eye image IL, which does not pass through the ½ wave plate 19, have characteristics of linearly polarized light beams that are perpendicular to each other.

The projection light beam carrying the right-eye image IR is incident on, and passes through, the polarization separation surface 21a of the polarization beam splitter 21 for optical-path separation as a P-polarized light beam. On the other hand, the projection light beam carrying the left-eye image IL is incident on the polarization separation surface 21a of the polarization beam splitter 21 for optical-path separation as S-polarized light and reflected thereby. Thus, the polarization beam splitter 21 for optical-path separation is an optical-path separation member that separates optical paths of the projection light beams, which have been given different optical characteristics by the ½ wave plate 19 from each other as an optical path of the right-eye image IR and an optical path of the left-eye image IL by using the difference in optical characteristic.

The projection light beam carrying the right-eye image IR passes through the optical-path length correction plate 23, reflected by the deflection mirror 22R, and then is incident on and passes through the polarization combining surface 24a of the polarization beam splitter 24 for combining optical paths as a P-polarized light beam. On the other hand, the projection light beam carrying the left-eye image IL, which has been reflected by the deflection mirror 22L, is incident on the polarization combining surface 24a of the beam splitter 24 for combining optical paths as an S-polarized light beam and reflected thereby. Thus, the polarization beam splitter 24 for combining optical paths is an optical-path combining member that coaxially combines the optical path of the right-eye image IR and the optical path of the left-eye IL, which have been separated from each other by the polarization beam splitter 21, by using the difference in optical characteristic.

The projection light beams carrying the images IR and IL and emitted from the polarization beam splitter 24 are projected via the projection lens 15 onto a screen in a superimposed state. That is, the projection lens 15, by using the projection light beams whose optical paths are coaxially combined by the polarization beam splitter 14, superimposingly projects the right-eye image IR and the left-eye image IL having different optical characteristics onto the screen. At this time, since the right-eye image IR and the left-eye image IL have different polarization characteristics, when the screen is seen via polarization glasses where a polarization plate that transmits merely the polarization component of the right-eye image IR is attached to its right-eye portion while a polarization plate that transmits merely the polarization component of the left-eye image IL is attached to its left-eye portion, the image projected onto the screen can be appreciated as a stereoscopic image.

The optical-path length correction plate 23 is an optical-path length correction member that corrects the difference in optical-path length between the right-eye image IR and the left-eye image IL such that the optical path of the right-eye image IR and the optical path of the left-eye image IL both have the same length from the display device 7 to the projection lens 15. As in the optical-path structure shown in FIG. 6, the polarization beam splitter 21 for optical-path separation and the polarization beam splitter 24 for combining optical paths carry out separation and combining, respectively, of polarized light at the same incidence angle, and a difference in optical-path length is corrected by the optical-path length correction plate 23 to eliminate the difference in length (corresponding to the distance A in FIG. 6) between the optical paths by using the difference in refractive index between the medium (such as glass) of the optical-path length correction plate 23 and air. As a result, since the optical paths of the light beams carrying the left and right parallax images are combined to achieve a state where there is no difference in optical-path length between the two images, there is no problem of one of the images being in focus while the other image being out of focus. That is, displacement due to difference in optical-path length does not occur between the focusing states of the left and right parallax images, and this allows both the right-eye image IR and the left-eye image IL to be projected onto the screen in a satisfactory focusing state.

In the second embodiment, by using the optical-path length correction plate 23 as described above, a compact arrangement of the optical-path separation and combining is achieved without allowing a difference in length between the optical paths, and furthermore, the combining of the two images IR and IL (see FIG. 2) is realized with a compact configuration by folding each optical path twice. Incidentally, instead of using the deflection mirror 22R, a right-angle prism may be used as an optical-path length correction member so as to fold the projection light beam carrying the right-eye image IR by being reflected within the right-angle prism. Sharing of the right-angle prism for the functions of the optical-path length correction plate 23 and the deflection mirror 22R in this way can contribute to the achievement of a compact and low-cost optical configuration.

In the second embodiment, since the difference in polarization characteristic is achieved by disposing the ½ wave plate 19 in the vicinity of a plane where the intermediate images 20 are formed, where images are less mixed with each other, optical-path separation as satisfactory as in the first embodiment can be performed by the polarization beam splitter 21 for optical-path separation even in a subsequent state in which the images are more mixed with each other. Thus, the optical-path separation carried out by using different optical characteristics, that is, difference in polarization characteristic, prevents the right-eye image IR and the left-eye image IL of the intermediate images 20 having a specific NA from mixing into each other in the optical-path separation. Thus, since the optical path of the light carrying the right-eye image and the optical path of the light carrying the left-eye image can be securely separated from each other, it is possible to prevent deterioration of image quality caused by mixture of the image light beams occurring at a boundary portion between the optical paths, and thus to realize a high-quality image projection. Furthermore, since projection is performed by using the single projection lens 15 as in the first embodiment, readjustment by the user is not necessary even when a setting condition such as the projection distance is changed, and since there is no difference in projection angle with respect to the screen between light beams carrying left and right parallax images, no difference in trapezoidal distortion occurs between the images. Furthermore, in contract to the first embodiment where the amount of light is reduced by half when the polarization plate absorbs needless polarization components to give the intermediate images different polarization characteristics, different optical characteristics can be efficiently given to the different intermediates image and a bright projection image can be obtained in the second embodiment, where polarization conversion is performed by the relay optical system 18 for projection before different polarization characteristics are given to the different intermediate images.

### First and Second Modified Examples of Relay Optical System for Projection

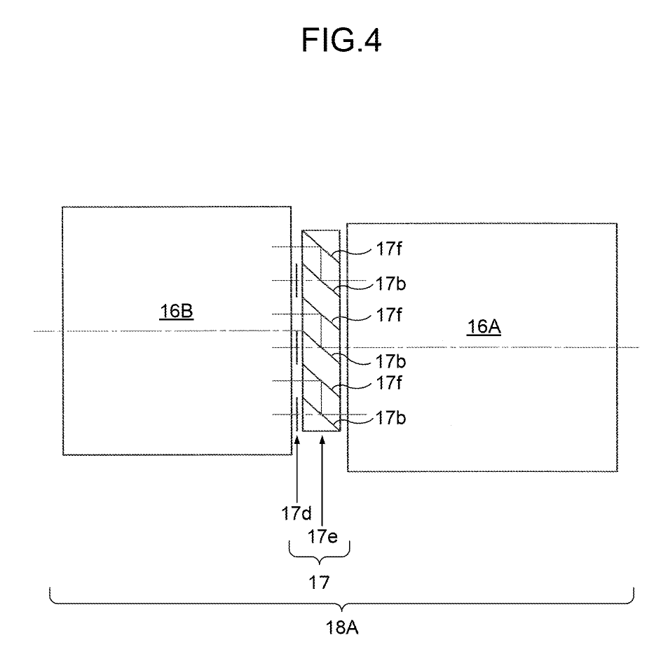

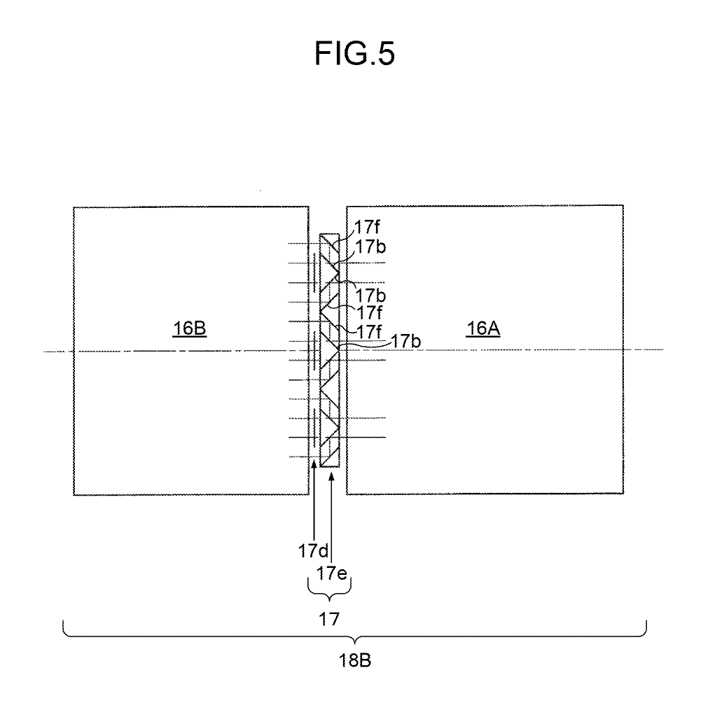

### FIGS. 4 and 5

FIG. 4 shows a first modified example (relay optical system 18A) of the relay optical system 18 for projection of the second embodiment (FIG. 3). A polarization conversion optical system 17, which is part of the relay optical system 18A, is different from its counterpart of the second embodiment. The relay optical system 18A for projection is formed of a front group 16B that is located closer to a screen than a pupil position is, a rear group 16A that is located closer to the display device 7 than the pupil position is, and the polarization conversion optical system 17 incorporated between the front group 16B and the rear group 16A. The polarization conversion optical system 17 is formed of: a polarization beam splitter array 17e in which a plurality of polarization separation surfaces 17b and reflection surfaces 17f facing the plurality of polarization separation surfaces 17b are arranged; and a plurality of ½ wave plates 17d placed at the pupil position. The polarization separation surfaces 17b are each tilted by 45° with respect to an optical axis (indicated by the dash-dot line) of the relay optical system 18A, and are arranged equally spaced and parallel to one another. The reflection surfaces 17f parallelly face the polarization separation surfaces 17b, and reflect light rays reflected from the polarization separation surfaces 17b to be parallel to light rays that has passed through the polarization separation surfaces 17b. The ½ wave plates 17d are arranged on the screen side of the polarization beam splitter array 17e, in the vicinity of the pupil position of the relay optical system 18A, so as to face the polarization separation surfaces 17b. Incidentally, the ½ wave plates 17d may be arranged to face the reflection surfaces 17f.

The pupil position of the relay optical system 18A for projection is conjugated with a pupil position of a relay optical system 5 for illumination, and a plurality of secondary light source images are formed at the pupil position. The ½ wave plates 17d are arranged at intervals corresponding to the positions of secondary light source images formed within the pupil of the relay optical system 18A. The polarization separation surfaces 17b separates projection light from the rear group 16A into P-polarized light that passes through the polarization separation surfaces 17b and S-polarized light that is reflected by the polarization separation surfaces 17b. The P-polarized light that has passed through the polarization separation surfaces 17b forms images in the vicinity of the ½ wave plates 17d as secondary light source images, and passes through the ½ wave plates to be converted to S-polarized light. On the other hand, the S-polarized light reflected by the polarization separation surfaces 17b is again reflected by the adjacent reflection surfaces 17f to form images, as S-polarization secondary light source images, at positions beside the ½ wave plates 17d where the S-polarized light converted from the originally P-polarized light forms images. Here, since the S-polarization travels as it is without passing through the ½ wave plates 17d, the projection light leaving the relay optical system 18A is all S-polarized with respect to the polarization separation surfaces 17b.

As described above, polarization is converted by generating a light source image of one polarization between each two adjacent light source images of another polarization, and thus the polarization state can be unified more efficiently by separating the polarization along a direction in which the light source images are distributed at a wider pitch. The secondary light source images are formed on the pupil plane of the relay optical system 18A according to how many times the light is reflected within the rod integrator 4 (see FIG. 3), and thus the secondary light source images are distributed at a wider pitch along the long-side direction of the section of the rod integrator 4. The long-side direction of the section of the rod integrator 4 corresponds to the long-side direction of the image display region of the display device 7, and thus, efficient polarization conversion can be achieved by unifying the polarization state by separating the polarization along this direction.

If the front group 16B and the rear group 16A of the relay optical system 18A are arranged such that the optical path of either P-polarized light or S-polarized light is made coaxial by the polarization conversion optical system 17, optical-path shift and optical-path length difference occur in the optical path of the other light. If the optical-path shift and the optical-path length difference are too large in amount, they will have an adverse effect on the image-forming performance of the relay optical system 18A. Since the first modified example (see FIG. 4) is configured such that polarization conversion is performed according to the pitch at which the secondary light source images are distributed, optical-path shift and optical-path length difference occur only to a smaller amount, and polarization conversion can be achieved with less deterioration of performance, in comparison with a case where polarization conversion is performed all along the optical path. Furthermore, the amount of optical-path shift can be made equal with respect to both of the polarization components, and the maximum value of the amount can be made small by arranging the front group 16B and the rear group 16A of the relay optical system 18A eccentric with respect to each other by the amount equivalent to half the arrangement interval of the polarization separation surfaces 17b (that is, by the amount corresponding to half the distance between the P-polarized light and the S-polarized light in the optical-path separation direction). This helps further reduce deterioration of performance caused by the optical-path shift.

FIG. 5 shows a second modified example (relay optical system 18B) of the relay optical system 18 for projection of the second embodiment (see FIG. 3). A polarization conversion optical system 17, which is part of the relay optical system 18B, is different from its counterpart of the second embodiment. The relay optical system 18B for projection is, as in the first modified example, formed of a front group 16B that is located closer to a screen than a pupil position is, a rear group 16A that is located closer to the display device 7 than the pupil position is, and the polarization conversion optical system 17 incorporated between the front and rear groups 16B and 16A. The polarization conversion optical system 17 is formed of: a polarization beam splitter array 17e in which a plurality of polarization separation surfaces 17b and reflection surfaces 17f facing the plurality of polarization separation surfaces 17b are arranged; and a plurality of ½ wave plates 17d placed at the pupil position. The polarization separation surfaces 17b are each tilted by 45° with respect to the optical axis (indicated by the dash-dot line) of the relay optical system 18B, but tilting directions (that is, optical-path separation directions) of adjacent polarization separation surfaces 17b are different from each other. The reflection surfaces 17f parallelly face the polarization separation surfaces 17b, and reflect light rays reflected from the polarization separation surfaces 17b to be parallel to light rays that has passed through the polarization separation surfaces 17b. The ½ wave plates 17d are arranged on the screen side of the polarization beam splitter array 17e, in the vicinity of the pupil position of the relay optical system 18B, so as to face the polarization separation surfaces 17b. Incidentally, the ½ wave plates 17d may be arranged to face the reflection surfaces 17f.

The optical-path shift can be limited to a small amount also by forming the polarization beam splitter array 17e such that the optical-path separation direction alternately changes as in the relay optical system 18B of the second modified example (see FIG. 5). And, with the configuration of the relay optical system 18B, in which the optical path of each secondary light source image is separated into two optical paths, it is possible to make the amount of optical-path shift of the S-polarization component the same as in the first modified example (see FIG. 4), and furthermore, to reduce the amount of difference in optical-path length by half compared to the first modified example (see FIG. 4), with no optical-path shift of the P-polarization component and without arranging the front group 16B and the rear group 16A eccentric with respect to each other.

### Features, Etc. of the Embodiments

As is clear from the description hereinabove, the first embodiment includes configurations of a stereoscopic-image projector described in (#1) to (#4) below, and the second embodiment includes configurations of a stereoscopic-image projector described in (#1) to (#3) and (#5) below.

(#1)

A stereoscopic image projector, including: a display device that displays a left-eye image which is a left parallax image and a right-eye image which is a right parallax image on different regions of an image display surface; a characteristic-differentiation member that gives optical characteristics that are different from each other to different projection light beams each carrying a different one of images displayed on the display device; an optical-path separation member that separates optical paths of the different projection light beams having obtained the optical characteristics that are different from each other at the characteristic-differentiation member into an optical path of the right-eye image and an optical path of the left-eye image by using a difference between the optical characteristics; an optical-path combining member that coaxially combines, by using the difference between the optical characteristics, the optical path of the right-eye image and the optical path of the left-eye image having been separated from each other by the optical-path separation member; and a single projection lens that superimposingly projects the right-eye image and the left-eye image having the optical characteristics that are different from each other onto a screen by using a projection light beam resulting from coaxial combining of optical paths performed by the optical-path combining member.

(#2)

A stereoscopic image projector, including: a display device that displays a left-eye image which is a left parallax image and a right-eye image which is a right parallax image on different regions of an image display surface; a relay optical system that forms an intermediate image of the right-eye image and an intermediate image of the left-eye image; a characteristic-differentiation member that gives optical characteristic that are different from each other to different projection light beams each carrying a different one of intermediate images formed by the relay optical system; an optical-path separation member that separates optical paths of the different projection light beams having obtained the optical characteristics that are different from each other at the characteristic-differentiation member into an optical path of the right-eye image and an optical path of the left-eye image by using a difference between the optical characteristics; an optical-path combining member that coaxially combines, by using the difference between the optical characteristics, the optical path of the right-eye image and the optical path of the left-eye image having been separated from each other by the optical-path separation member; and a single projection lens that superimposingly projects the right-eye image and the left-eye image having the optical characteristics that are different from each other onto a screen by using a projection light beam resulting from coaxial combining of optical paths performed by the optical-path combining member.

(#3)

The stereoscopic image projector described in (#1) or (#2), characterized in that the optical characteristics that are different from each other are polarization characteristics of linearly polarized light beams that are perpendicular to each other.

(#4)

The stereoscopic image projector described in any one of (#1) to (#3), characterized in that the optical-path separation member has an optical-path separation surface, that the optical-path combining member has an optical-path combining surface, that an incidence angle on the optical-path separation surface is different from an incidence angle on the optical-path combining surface with respect to both of the optical path of the right-eye image and the optical path of the left-eye image, and that the optical path of the right-eye image and the optical path of the left-eye image have a same length from the display device to the projection lens.

(#5)

The stereoscopic image projector described in any one of (#1) to (#3), further including: an optical-path length correction member that corrects a difference in optical-path length between the optical path of the right-eye image and the optical path of the left-eye image such that there is no difference in length from the display device to the projection lens between the optical path of the right-eye image and the optical path of the left-eye image.

According to the configuration described in (#1) or (#2), since the optical-path separation member separates the optical path of each of the projection light beams that differ from each other in optical characteristic is separated into the optical path of the right-eye image and the optical path of the left-eye image by using the difference in optical characteristic, separation of the optical paths of the right-eye and left-eye images from each other can be securely achieved. For example, optical-path separation can be achieved even with respect to a widely spread light beam, and it is possible even for a bright optical system having a small F-number to efficiently separate or combine optical paths. Thus, image quality degradation caused by mixing of image light occurring at boundary portions of the optical paths can be prevented while achieving a compact stereoscopic image projector capable of performing high-quality image projection. For example, it is possible to achieve, with a compact configuration, efficient optical-path separation that is required to achieve the combining of optical paths by using a single display device and a single projection lens.

In addition, since projection is performed with a single projection lens by combining the optical paths of the right-eye and left-eye images, it is possible to save a user trouble of adjusting superimposition corresponding to various setting conditions. By constantly displaying the right-eye image and the left-eye image in different image display regions of the display device, it is possible, by using a single projector, to realize a smooth display of a stereoscopic moving image without an undesired phenomenon such as flickering, which is observed in a case of time-division display.

Examples of the “optical characteristic” include, in addition to the polarization characteristic, the wavelength characteristic (that is, the chromatic characteristic). For example, in the first embodiment (see FIG. 1), first and second color filters may be used instead of the first and second polarization plates 9R and 9L. The transmissivity of the first color filter is such that it transmits only variations of each of RGB within a band of a short-wavelength side. The transmissivity of the second color filter is such that it transmits only variations of each of RGB within a band on a long-wavelength side.

According to the configuration described in (#2), by forming intermediate images of the right-eye and left-eye images by using the relay optical system and, for example, arranging optical members such as a polarization plate, a wave plate, a filter, and the like at or in the vicinity of the intermediate image position as a characteristic-differentiation member, it is possible to give different optical characteristics to the right-eye and left-eye images. In a case where a reflection-type display device (such as a digital micromirror device) is used, it is not easy to arrange the characteristic-differentiation member giving different optical characteristics as described above, partly due to the effect of illumination light. Forming the intermediate images by a relay optical system, however, makes it easy to arrange the characteristic-differentiation member that gives optical characteristics that are different from each other.

According to the configuration described in (#3), polarization characteristics of linearly polarized light beams perpendicular to each other are given to the right-eye image and the left-eye image, and thus, for example, use of optical members such as a polarization beam splitter and a wire grid facilitates the separation and combining of light beams. Furthermore, use of the polarization characteristics makes it possible to appreciate stereoscopic images with inexpensive polarization glasses.

According to the configuration (#4), the incidence angle on the optical-path separating surface is different from the incidence angle on the optical-path combining surface with respect to the optical paths of both of the right-eye image and the left-eye image, and thus the optical-path lengths of the two images from the display device to the projection lens can be made equal to achieve a projection where both of left and right parallax images are in focus in spite of using only a single projection lens. Incidentally, examples of the optical-path separation surface include one formed of a multilayer film and one formed of a wire grid, and examples of the optical-path combining surface include one formed of a multilayer film and one formed of a wire grid.

According to the configuration described in (#5), which includes the optical-length correction member correcting the difference in optical-path length between the right-eye image and the left-eye image, the optical-path lengths from the display device to the projection lens can be made equal to achieve projection where both of left and right parallax images are in focus in spite of using only a single projection lens.

What is claimed is:

1. A stereoscopic image projector, comprising:
a display device that displays a left-eye image which is a left parallax image and a right-eye image which is a right parallax image on different regions of an image display surface;
a characteristic-differentiation member that gives optical characteristics that are different from each other to different projection light beams each carrying a different one of images displayed on the display device;
an optical-path separation member that separates optical paths of the different projection light beams having obtained the optical characteristics that are different from each other at the characteristic-differentiation member into an optical path of the right-eye image and an optical path of the left-eye image by using a difference between the optical characteristics;
an optical-path combining member that coaxially combines, by using the difference between the optical characteristics, the optical path of the right-eye image and the optical path of the left-eye image having been separated from each other by the optical-path separation member; and
a single projection lens that superimposingly projects the right-eye image and the left-eye image having the optical characteristics that are different from each other onto a screen by using a projection light beam resulting from coaxial combining of optical paths performed by the optical-path combining member.

2. The stereoscopic image projector of claim 1, wherein the optical characteristics that are different from each other are polarization characteristics of linearly polarized light beams that are perpendicular to each other.

3. The stereoscopic image projector of claim 1,
wherein
the optical-path separation member has an optical-path separation surface,
the optical-path combining member has an optical-path combining surface,
an incidence angle on the optical-path separation surface is different from an incidence angle on the optical-path combining surface with respect to both of the optical path of the right-eye image and the optical path of the left-eye image, and
the optical path of the right-eye image and the optical path of the left-eye image have a same length from the display device to the projection lens.

4. The stereoscopic image projector of claim 1, further comprising:
an optical-path length correction member that corrects a difference in optical-path length between the optical path of the right-eye image and the optical path of the left-eye image such that there is no difference in length from the display device to the projection lens between the optical path of the right-eye image and the optical path of the left-eye image.

5. A stereoscopic image projector of claim 2,
wherein
the optical-path separation member has an optical-path separation surface,
the optical-path combining member has an optical-path combining surface,
an incidence angle on the optical-path separation surface is different from an incidence angle on the optical-path combining surface with respect to both of the optical path of the right-eye image and the optical path of the left-eye image, and
the optical path of the right-eye image and the optical path of the left-eye image have a same length from the display device to the projection lens.

6. The stereoscopic image projector of claim 2, further comprising:
an optical-path length correction member that corrects a difference in optical-path length between the optical path of the right-eye image and the optical path of the left-eye image such that there is no difference in length from the display device to the projection lens between the optical path of the right-eye image and the optical path of the left-eye image.

7. A stereoscopic image projector comprising:
a display device that displays a left-eye image which is a left parallax image and a right-eye image which is a right parallax image on different regions of an image display surface;
a relay optical system that forms an intermediate image of the right-eye image and an intermediate image of the left-eye image;
a characteristic-differentiation member that gives optical characteristic that are different from each other to different projection light beams each carrying a different one of intermediate images formed by the relay optical system;
an optical-path separation member that separates optical paths of the different projection light beams having obtained the optical characteristics that are different from each other at the characteristic-differentiation member into an optical path of the right-eye image and an optical path of the left-eye image by using a difference between the optical characteristics;
an optical-path combining member that coaxially combines, by using the difference between the optical characteristics, the optical path of the right-eye image and the optical path of the left-eye image having been separated from each other by the optical-path separation member; and
a single projection lens that superimposingly projects the right-eye image and the left-eye image having the optical characteristics that are different from each other onto a screen by using a projection light beam resulting from coaxial combining of optical paths performed by the optical-path combining member.

8. The stereoscopic image projector of claim 7, wherein the optical characteristics that are different from each other are polarization characteristics of linearly polarized light beams that are perpendicular to each other.

9. The stereoscopic image projector of claim 7,
wherein
the optical-path separation member has an optical-path separation surface,
the optical-path combining member has an optical-path combining surface,
an incidence angle on the optical-path separation surface is different from an incidence angle on the optical-path combining surface with respect to both of the optical path of the right-eye image and the optical path of the left-eye image, and
the optical path of the right-eye image and the optical path of the left-eye image have a same length from the display device to the projection lens.

10. The stereoscopic image projector of claim 7, further comprising:
an optical-path length correction member that corrects a difference in optical-path length between the optical path of the right-eye image and the optical path of the left-eye image such that there is no difference in length from the display device to the projection lens between the optical path of the right-eye image and the optical path of the left-eye image.

11. The stereoscopic image projector of claim 8,
wherein
the optical-path separation member has an optical-path separation surface,
the optical-path combining member has an optical-path combining surface,
an incidence angle on the optical-path separation surface is different from an incidence angle on the optical-path combining surface with respect to both of the optical path of the right-eye image and the optical path of the left-eye image, and
the optical path of the right-eye image and the optical path of the left-eye image have a same length from the display device to the projection lens.

12. The stereoscopic image projector of claim 8, further comprising:
an optical-path length correction member that corrects a difference in optical-path length between the optical path of the right-eye image and the optical path of the left-eye image such that there is no difference in length from the display device to the projection lens between the optical path of the right-eye image and the optical path of the left-eye image.
